(19) United States
(12) Patent Application Publication
(10) Pub. No.: US 2007/0196000 A1
(43) Pub. Date: Aug. 23, 2007

(54) 2D face authentication system

(75) Inventor: Josef Kittler, Surrey (GB)

Correspondence Address: STITES & HARBISON PLLC, 1199 NORTH FAIRFAX STREET, SUITE 900, ALEXANDRIA, VA, 22314, US

(73) Assignee: Omniperception Limited, Shalford, Guildford, Surrey (GB)

(21) Appl. No.: 10/578,715

(22) PCT Filed: Nov. 10, 2004
(86) PCT No.: PCT/GB04/04748

§ 371 Date: Apr. 17, 2007

(30) Foreign Application Priority Data
Nov. 10, 2003 (GB) 0326186.4

(51) Int. Cl. G06K 9/00

(52) U.S. Cl. 382/118

(57) ABSTRACT

A novel approach to 2D face authentication that is assisted by client specific 3D models is proposed. Each 3D model is acquired during the client enrolment together with the usual client template. Any 3D face model acquisition system may be used for the purpose. The future authentication of client's identity by the face biometric system is based on 2D probe only, with the stored 3D model and the client template used for reference. In a verification scenario, the authentication process is assisted by the 3D model associated to the claimed identity.

Existing 2D image based face authentication systems involve capturing a user's face image, a so called probe, which is first registered geometrically and subsequently normalised photometrically. Certain features are then computed from the normalised image and compared with a stored model (one of several templates defined in the feature space). The creation of the template is referred to as training. If the authentication process is verification, the comparison is carried out against the model of the claimed identity. If the process is identification, all models in the database are matched against the probe image and the best match determines the unknown identity of the tested individual.

2D image based face authentication systems are notoriously sensitive to changes in illumination and pose of the subject. A number of solutions have been suggested to alleviate the pose problem. For instance, one can use a multi view model where the templates for each user, generated during the enrolment, represent different pose views of the face. However, such an approach has a number of problems. First of all, registering a probe image of an arbitrary pose geometrically is very difficult. Also the complexity of the system increases, as a different feature space is needed for each pose. Alternatively, one can build a statistical model which captures the variations of the face over a range of poses. The resulting statistical 2D face appearance model is then fitted to the probe image. It is then possible to elicit the discriminatory information content encapsulated by the appearance model and use it for authentication. Similarly, one can build a 3D statistical model of the human face and use it for pose fitting. The problem with such approaches is that each time a new client is enrolled by the system, it should be retrained and when the system is retrained, all existing clients have to be issued with new templates. This is time consuming, and in many applications impracticable. Without system retraining, any errors arising from the inability of the system to model well the pose of the face captured in the probe image may interfere with the subsequent matching process to establish the identity of the probe image. More over, such approaches are dramatically affected by changes in illumination.

The recent work of Zhao and Chellappa [WY Zhao and R Chellappa, 3D model enhanced face recognition, Proceedings IEEE International Conference on Image Processing 2000, Vancouver, Canada] suggests that both pose and illumination variations can be handled successfully, provided a general 3D face model is used to aid 2D processing. The model can be used to re-map the probe image into the frontal pose presentation and correct it for changes in illumination at the same time. The advantage of the system is that it does not require retraining when a new user is enrolled. However, as with the 2D and 3D statistical models discussed above, the residual errors resulting from the fitting of a generic 3D face model to a 2D face image of a specific user will lead to registration errors and consequently to recognition errors.

According to the invention there is provided a 2D face authentication process utilising a client specific 3D face shape model. According to the invention there is further provided an enrolment process for a face authentication process including acquiring, for each client, a template for 2D based face authentication and a client specific 3D face shape model. We propose a novel approach to 2D face authentication that is assisted by client specific 3D models. Each model is acquired during the client enrolment together with the usual client template. Any 3D face model acquisition system may be used for the purpose. The future authentication of client's identity by the face biometric system is based on 2D probe only, with the stored 3D model and the client template used for reference. In a verification scenario, the authentication process is assisted by the 3D model associated to the claimed identity. The 3D face model is registered with the observed probe image, which is then re-mapped to the frontal face presentation. The re-mapped image is normalised photometrically, based on the algorithm of Zhao and Chellappa. In contrast with their work, the client specific 3D model is used to compute the face shape derivatives needed for the photometric normalisation process, rather than the derivatives of the general face model. This is more accurate and consequently yields better results. The pose and illumination corrected image is then input to the 2D face verification subsystem of the face authentication system to obtain the final decision about the claimed identity.

In an identification scenario, the system successively hypothesises the identities of the users known to the system. For each hypothesis the process of 3D model to probe image registration, pose correction and photometric normalisation are carried out as detailed above for the verification process. The scores of the matches achieved for the respective hypotheses are ranked in the descending order. The highest scoring hypothesis then defines the identity of the probe image.

In addition to the above face authentication process, the process of acquiring for each client, during the enrolment, a 3D face shape model together with a template for 2D based face authentication is also claimed to be novel. The process of acquiring for each client, during enrolment, a 3D face shape model jointly with a template for 2D based face authentication and then acquiring only 2D face image probe for future authentication, with the stored client specific 3D face shape model used to aid the authentication process is also claimed to be novel. The advantage of this approach is that the authentication system does not need to be retrained on enrolling new clients and client templates do not need to be re-issued.

1. A 2D face authentication process utilizing a client specific 3D face shape model.

2. A 2D face authentication process as claimed in claim 1 wherein said client specific 3D face shape model is used to generate data required for pose and illumination normalisation.

3. A 2D face authentication process as claimed in claim 2 wherein said data includes face shape derivatives.

4. An enrolment process for a 2D face authentication process including acquiring, for each client, a template for 2D based face authentication and a client specific 3D face shape model.

5. A 2D face authentication system using the 2D face authentication process claim 1.

6. A 2D face authentication system using the enrolment process of claim 4.

7.-9. (canceled)
